(19) United States
(12) Patent Application Publication
(10) Pub. No.: US 2002/0161613 A1
(43) Pub. Date: Oct. 31, 2002

(54) Message-address management program, recording medium carrying message-address management program, message-address management method, and message-address management apparatus

(75) Inventor: Toshihide Hida, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 09/963,952

(22) Filed: Sep. 26, 2001

(30) Foreign Application Priority Data
Apr. 26, 2001 (JP) 2001-129103

(51) Int. Cl. G06F 17/60

(52) U.S. Cl. 705/7

(57) ABSTRACT

When a mail address changed, first server receives absence response information containing an old address and a new address corresponding to the change, extracts a mail address of each of other members from a mailing list based on the old address, obtains domain information corresponding to the extracted mail address, and distributes the absence response information to second server specified based on the domain information. The second server receives and stores the absence response information. Upon acceptance a mail from a client, the second server judges whether the mail is directed to the old address and changes the address of the mail to the new address and sends the mail.

### BACKGROUND OF THE INVENTION

1. Field of the Invention

The present invention relates to a mail-address management program, and in particular, to a mail-address management program for address-change notification/automatic message transfer which is used in an information processing system capable of performing message exchange, such as an electronic mail system, and which operates in response to, for example, a change in mail address, and efficiently performs distribution of response information corresponding to the change, and automatic transfer of messages to a new address. The present invention further relates to a recording medium carrying message-address management program, a message-address management method and a message-address management apparatus for address-change notification/automatic message transfer which is used in an information processing system capable of performing message exchange.

2. Description of the Related Art

In a conventional message exchange system; e.g., an electronic mail system utilizing the Internet, proper deliver of electronic mails becomes impossible when a mail address is changed and the mail address before being changed (old address) becomes unusable. That is, when a third person who has not become aware of such an address change transmits an electronic mail directed to the old address, the electronic mail becomes an error mail (unknown).

The above problem has conventionally been solved as follows. In a mail delivery system (mail server) corresponding to a domain of the mail address, through use of an alias function, the mail address after being changed (new address) is set as an alias; and when a mail directed to the old address is to be delivered, the mail is delivered after replacement of the old address with the new address.

Such a message exchange system (e.g., electronic mail system) has become popular as business communication means. In the case of an electronic mail system, mail addresses are generally allocated to members of each section while being grouped on a section-by-section basis. Therefore, mail addresses are frequently changed due to personnel changes and other causes. In such a case, error mails may be generated unless such changes in mail addresses are announced to all concerned parties at an appropriate time.

Conventionally, when an error mail is generated in an electronic mail system, a mail server which has received the error mail copes with the error mail by issuing an error response a predetermined (plurality) number of times, and, after the error response, solves the problem by means of alias transfer. However, these measures are post factum solutions; i.e., are effected after generation of the error mail. In other words, since generation of error mails cannot be predicted or prevented, the following problems have occurred.

1) Useless traffic of error mails is produced between mail servers. That is, after generation of an error mail, a transfer-destination address (or a new address) is obtained in order to update an old mail address, and therefore error response is typically generated five times. Further, even when alias transfer is performed, there are produced useless traffic toward a mail server corresponding to the old address and useless traffic between the mail server corresponding to the old address and a mail server corresponding to the new address. In particular, in a large company, generation of a large number of error mails greatly increases useless traffic, thereby hindering the proper operational environment.

2) Since an administrator of each mail server cannot predict generation of an error mail, the administrator must analyze an error log after generation of an error mail and change the corresponding address.

The following two points are important in predicting and preventing generation of error mails.

1) Each mail server must grasp changes in mail addresses within its domain and, in advance, distribute to other mail servers information regarding the changes.

2) Each mail server must specify parties to which mail address changes are to be announced.

### SUMMARY OF THE INVENTION

An object of the present invention is to provide a message-address management program which prevents generation of error mails due to address changes.

Another object of the present invention is to provide a message-address management program which reduces useless traffic of generated error mails and lessens the load imposed on an administrator in relation to generation of error mails.

Another object of the present invention is to provide a message-address management program which provides absence response information to a server for maintaining a proper environment of message exchange.

An object of the present invention is to provide a recording medium recorded message-address management program which prevents generation of error mails due to address changes.

Another object of the present invention is to provide a recording medium recorded message-address management program which reduces useless traffic of generated error mails and lessens the load imposed on an administrator in relation to generation of error mails.

Another object of the present invention is to provide a recording medium recorded message-address management program which provides absence response information to a server for maintaining a proper environment of message exchange.

An object of the present invention is to provide a message-address management method which prevents generation of error mails due to address changes.

Another object of the present invention is to provide a message-address management method which reduces useless traffic of generated error mails and lessens the load imposed on an administrator in relation to generation of error mails.

Another object of the present invention is to provide a message-address management method which provides absence response information to a server for maintaining a proper environment of message exchange.

An object of the present invention is to provide a message-address management apparatus which prevents generation of error mails due to address changes.

Another object of the present invention is to provide a message-address management apparatus which reduces useless traffic of generated error mails and lessens the load imposed on an administrator in relation to generation of error mails.

Another object of the present invention is to provide a message-address management apparatus which provides absence response information to a server for maintaining a proper environment of message exchange.

The present invention provides a message-address management program for causing a computer to perform message-address management processing in a system capable of exchanging messages among a plurality of servers, and is used to operate a first or second or third computer which constitutes the message exchange system.

The program according to the present invention causes a first computer to perform absence-response-information accepting processing to receive, when a mail address of a certain member of a mail group changes, absence response information including at least an old address and a new address of the member; notice-receiver extraction processing to extract a mail address of another member of the mail group from a previously provided mail list for the mail group; notice-destination determination processing to specify a server to which the absence response information is to be provided, on the basis of the extracted mail address; and absence-response-information distribution processing to distribute the absence response information to the specified server.

The program according to the present invention causes a second computer to perform absence-response-information receiving processing to receive from a server absence response information including at least an old address and a new address of a certain member of a mail group who uses the server; absence-response-information management processing to store and manage the absence response information, address judgment processing to judge whether an address of an accepted transmission mail matches the old address contained in the absence response information; and transfer processing to transmit the mail after replacement of the address with the new address, when the address of the mail matches the old address contained in the absence response information.

The program according to the present invention causes a third computer to perform absence-response-information creation processing to accept, when a mail address changes, an input data of absence response information including at least an old address and a new address corresponding to the change; and absence-response-information provision processing to transmit the input data of the absence response information to the first computer.

Further, the present invention provides a program recording medium which is recorded a program to cause a first computer to perform absence-response-information accepting processing to receive, when a mail address of a certain member of a mail group changes, absence response information including at least an old address and a new address of the member; notice-receiver extraction processing to extract a mail address of another member of the mail group from a previously provided mail list for the mail group; notice-destination determination processing to specify a server to which the absence response information is to be provided, on the basis of the extracted mail address; and absence-response-information distribution processing to distribute the absence response information to the specified server.

Moreover, the present invention provides a program recording medium which is recorded a program to cause a second computer to perform absence-response-information receiving processing to receive from a server absence response information including at least an old address and a new address of a certain member of a mail group who uses the server; absence-response-information management processing for to store and manage the absence response information; address judgment processing to judge whether an address of an accepted transmission mail matches the old address contained in the absence response information; and transfer processing to transmit the mail after replacement of the address with the new address, when the address of the mail matches the old address contained in the absence response information.

Further, the present invention provides a program recording medium which is recorded a program to cause a third computer to perform absence-response-information creation processing to accept, when a mail address changes, an input data of absence response information including at least an old address and a new address corresponding to the change; and absence-response-information provision processing to transmit the input data of the absence response information to the server.

Further, the present invention provides a method comprising the steps of receiving, when a mail address of a certain member of a mail group changes, absence response information including at least an old address and a new address of the member; extracting a mail address of another member of a mail group from a previously provided mail list for the mail group; specifying a server to which the absence response information is to be provided, on the basis of the extracted mail address; and distributing the absence response information to the specified server.

Moreover, the present invention provides a method comprising the steps of receiving from a server absence response information including at least an old address and a new address of a certain member of a mail group who uses the server; storing and managing the absence response information; judging whether an address of an accepted transmission mail matches the old address contained in the absence response information; and transmitting the mail after replacement of the address with the new address, when the address of the mail matches the old address contained in the absence response information.

Further, the present invention provides method for exchanging messages among a plurality of servers, the method comprising the steps of accepting, when a mail address changes, an input data of absence response information including at least an old address and a new address corresponding to the change; and transmitting the input data of the absence response information to the server.

Further, the present invention provides an apparatus comprising absence-response-information accepting means for receiving, when a mail address of a certain member of a mail group changes, absence response information including at least an old address and a new address of the member; notice-receiver extraction means for extracting a mail address of another member of the mail group from a previously provided mail list for the mail group; notice-destination determination means for specifying a server to which the absence response information is to be provided, on the basis of the extracted mail address; and absence-response-information distribution means for distributing the absence response information to the specified server.

The present invention provide an apparatus comprising absence-response-information receiving means for receiving from a server absence response information including at least an old address and a new address of a certain member of a mail group who uses the server; absence-response-information management means for storing and managing the absence response information; address judgment means for judging whether an address of an accepted transmission mail matches the old address contained in the absence response information; and transfer means for transmitting the mail after replacement of the address with the new address, when the address of the mail matches the old address contained in the absence response information.

Further, the present invention provides an apparatus comprising absence-response-information creating means for accepting, when a mail address changes, an input data of absence response information including at least an old address and a new address corresponding to the change; absence-response-information providing means for transmitting the input data of the absence response information to the mail server.

In the present invention, upon occurrence of a mail address change, a server (mail server) having a mail delivery function for a domain in which the mail address change has occurred provides another mail server with absence response information corresponding to the mail address change; and the mail server which has received the absence response information registers the absence response information in the mail server itself or in an address management server, and when a mail directed to the old address contained in the absence response information is to be transmitted, the mail server transfers the mail to the new mail address.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a diagram showing respective means and functions which realize the present invention in an embodiment;

FIG. 2 is a diagram showing an example configuration of a system according to the embodiment of the present invention;

FIG. 3 is a diagram showing an example of an absence-response-list input screen;

FIG. 4 is a table showing an example input-data format of an absence response list;

FIG. 5 is a table showing an example member list of a mailing list;

FIG. 6 is a table showing example data of domain information;

FIG. 7 is a table showing an example notice-destination domain file;

FIG. 8 is a table showing an example notification message to be sent to a postmaster;

FIG. 9 is a processing flowchart of a mail server for a domain abc.abcd.co.jp;

FIG. 10 is a processing flowchart of a scheduler for the domain abc.abcd.co.jp;

FIG. 11 is a processing flowchart (absence response list reception processing) of a mail server for a domain efg.abcd.co.jp; and

FIG. 12 is a processing flowchart (transfer processing) of the mail server for the domain efg.abcd.co.jp.

### DESCRIPTION OF THE PREFERRED EMBODIMENT

The embodiment shows a case in which the present invention is applied to an electronic mail system.

When a mail address of a certain member of a mail group changes, absence response information including at least an old address and a new address of the member is provided from a client. The first computer (first server) which executes the program according to the present invention accepts the absence response information and extracts, as a party to which the absence response information is to be provided, a mail address of each of other members of the mail group from a transmission address list such as a mailing list previously stored in the server itself. Subsequently, on the basis of the extracted mail address, the first computer obtains, from a DNS (Domain Name System) server, domain information (host name, domain name, domain administrator mail address) corresponding to the extracted mail address, specifies a server to which the absence response information is to be provided, and distributes the absence response information to the specified server.

Further, the present invention utilizes a mailing list in order to specify parties to which the absence response information is to be provided. The mailing list is a database for storing mail addresses of members to which mails are delivered. Such a database is used in a system for exchanging between specific members information regarding a specific topic or content. Alternatively, the mailing list is a list of mail addresses relating to a specific mail address. Since parties to which the absence response information is to be provided are extracted by use of an existing mailing list stored in the mail server, storage of a new database for distributing the absence response information is not required. Further, recently, a mailing list is utilized frequently in relation to performance of business operation, and mails are conceivably exchanged frequently among the members of the mailing list (i.e., the members of a mail group). Therefore, if such members are selected as parties to which the absence response information is to be provided, generation of error mails can be prevented effectively.

The second computer (second server) which executes the program according to the present invention receives the absence response information from the first server in which a mail address change has occurred; and stores and manages the absence response information. Subsequently, the second computer judges whether an address of a transmission mail received from a client matches the old address contained in the absence response information. When the address of the mail matches the old address contained in the absence response information, the second computer transmits the mail after replacement of the address with the new address. Further, when the mail has been transferred to the new address, the second computer notifies an administrator of the message exchange system or a requester of the mail transmission that the mail has been transferred to the new address.

As described above, when a mail directed to a mail address having been changed is transmitted, the second server which has accepted the mail can detect that the mail address is the old address and transmit the mail after replacing the old address with the new address. Thus, generation of error mails can be prevented, and useless traffic occurring due to transmission of error mails to the first server and transmission of error responses can be suppressed.

Moreover, since performance of mail transfer is notified to the administrator of the second server or the requestor of the mail transmission, the administrator of the second server is released from the work of analyzing an error log and coping with the error, so that the workload of administrator can be lessened. In addition, the requestor of the mail transmission can become aware that the mail has been transferred to the new address.

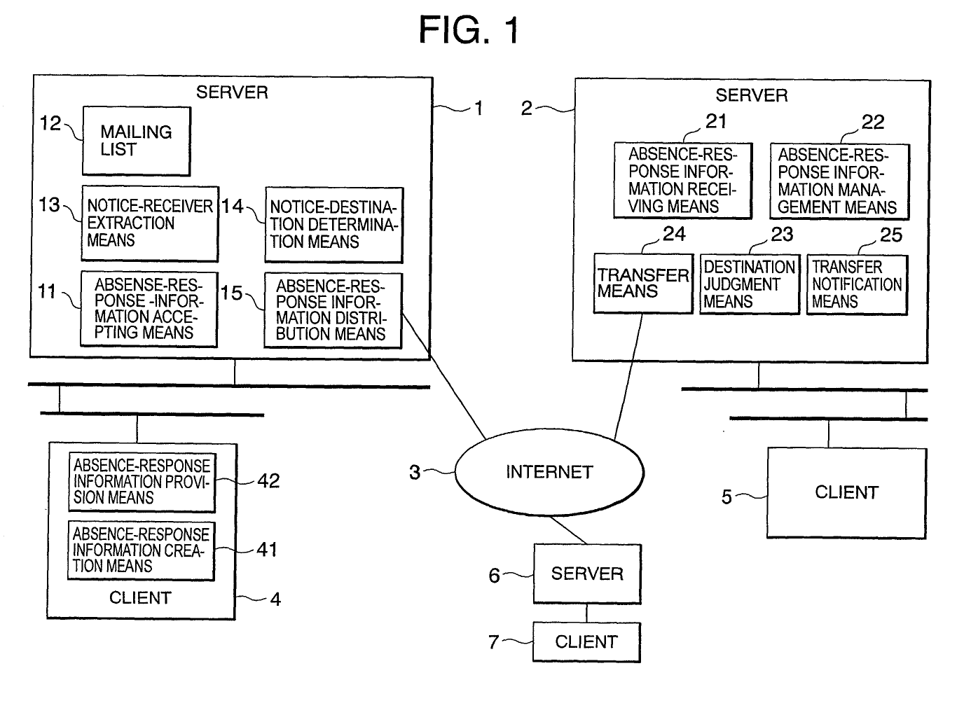

FIG. 1 shows respective means and functions which realize the present invention in the embodiment. The electronic mail system according to the present invention includes servers 1 and 2, which are connectable to the Internet 3 and each have a mail delivery function.

The mail delivery functions provided in the servers 1 and 2 include a delivery function that operates in accordance with SMTP (Simple Mail Transfer Protocol) and a reception function that operates in accordance with POP (Post Office Protocol). However, the functions provided in the servers 1 and 2 are not limited thereto, so long as the functions enable delivery of messages.

A client 4 is a mail client connected to the server 1 via a communication line; and a client 5 is a mail client connected to the server 2 via another communication line. However, these clients 4 and 5 may be connected to the servers 1 and 2, respectively, by means of radio.

The server 1 includes absence-response-information accepting means 11, a plurality of mailing lists 12 corresponding to a plurality of mail groups, notice-receiver extraction means 13, notice-destination determination means 14, and absence-response-information distribution means 15.

The absence-response-information accepting means 11 receives input data of absence response information transmitted by the client 4 and registers the absence response information. The absence response information includes at least an old mail address and a new mail address. In addition to these, the absence response information contains a valid period of the absence response information, a flag indicating whether the absence response information is to be provided to a mail server administrator (postmaster) serving as a notice receiver, a receiver to which the absence response information is to be distributed (hereinafter may be referred to as a “notice-receiver”), and a reason for mail transfer.

Among the mailing lists 12 stored in the server 1, the notice-receiver extraction means 13 searches a mailing list 12 that contains the old mail address contained in the absence response information and extracts mail addresses of other members contained in the searched mailing list 12.

In order to specify a mail server, which serves as a notice receiver, on the basis of the corresponding mail address extracted by the notice-receiver extraction means 13, the notice-destination determination means 14 obtains domain information of the mail server, such as host name, domain name, and domain administrator mail address. The domain information can be obtained through an operation of inquiring a DNS (Domain Name System) server by use of, for example, the nslookup command of BIND (Berkeley Internet Name Domain). In the present embodiment, domain information regarding the server 2, which is a notice-receiver, can be obtained.

The absence-response-information distribution means 15 transmits the absence response information to the server 2 while using, as a destination address, a combination of the host name and the domain name obtained by the notice-destination determination means 14. When the server 1 has a scheduler function, by use of the scheduler function, the server 1 transmits a piece of absence response information or a plurality of pieces of absence response information simultaneously to the server 2 at a predetermined time or occasion.

The client 4 connected to the server 1 includes absence-response-information creation means 41 and absence-response-information provision means 42. The absence-response-information creation means 41 displays a predetermined data input screen to thereby permit a user to input absence response information by use of input means (not shown) such as a keyboard and a mouse, and accepts the input data of the absence response information. The absence-response-information provision means 42 transmits the input data of the absence response information to the server 1.

The server 2 includes absence-response-information receiving means 21, absence-response-information management means 22, address judgment means 23, transfer means 24, and transfer notification means 25.

The absence-response-information receiving means 21 receives the data of the absence response information input to the server 1. The absence-response-information management means 22 stores and manages the received absence response information. When a notification valid period is set for the received absence response information, the absence-response-information management means 22 erases the absence response information after passage of the notification valid period. Notably, the absence response information may be managed not in a server having a mail delivery function, but in a server having an address management function.

Upon acceptance of a mail transmission from the client 5, the address judgment means 23 judges whether the transmission address matches the old mail address contained in the absence response information managed by the absence-response-information management means 22. When the transmission destination matches the old mail address contained in the absence response information, the address judgment means 23 requests the transfer means 24 to transfer the mail.

Upon reception of the transfer request from the address judgment means 23, the transfer means 24 transmits the mail after replacing the old mail address with the new mail address.

The transfer notification means 25 reports occurrence of the mail transfer to either or both of the administrator (postmaster) of the server 2 and the client 5.

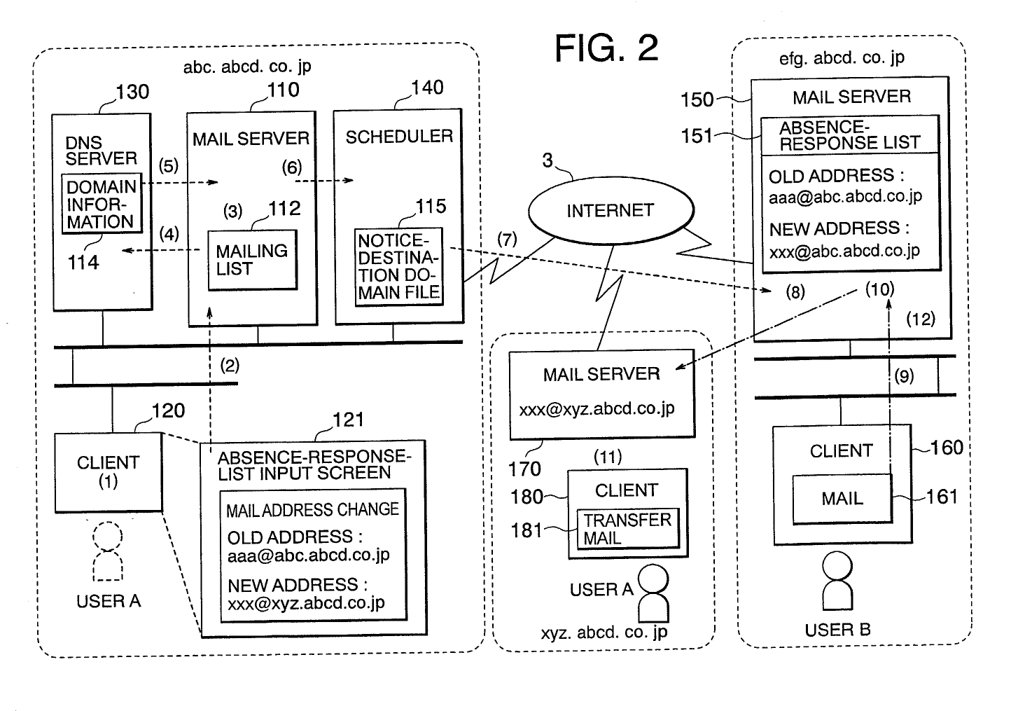

The processing of the system according to the present invention will be described in more detail with reference to FIGS. 2 to 8. The description is based on the assumption that, as shown in FIG. 2, a user A belonging to a domain abc.abcd.co.jp has moved to a domain xyz.abcd.co.jp, and the mail address of the user A has been changed from aaa@abc.abcd.co.jp to xxx@xyz.abcd.co.jp, and that a user B belonging to a domain efg.abcd.co.jp and the user A are members of the same mail group.

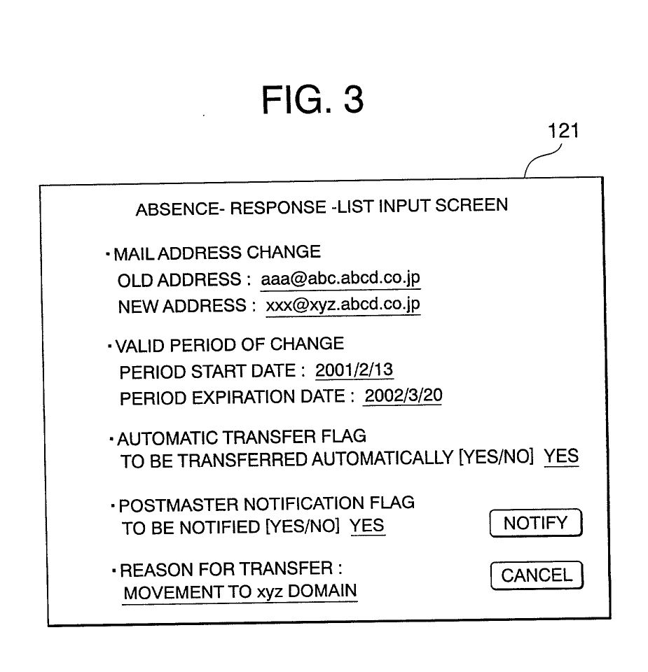

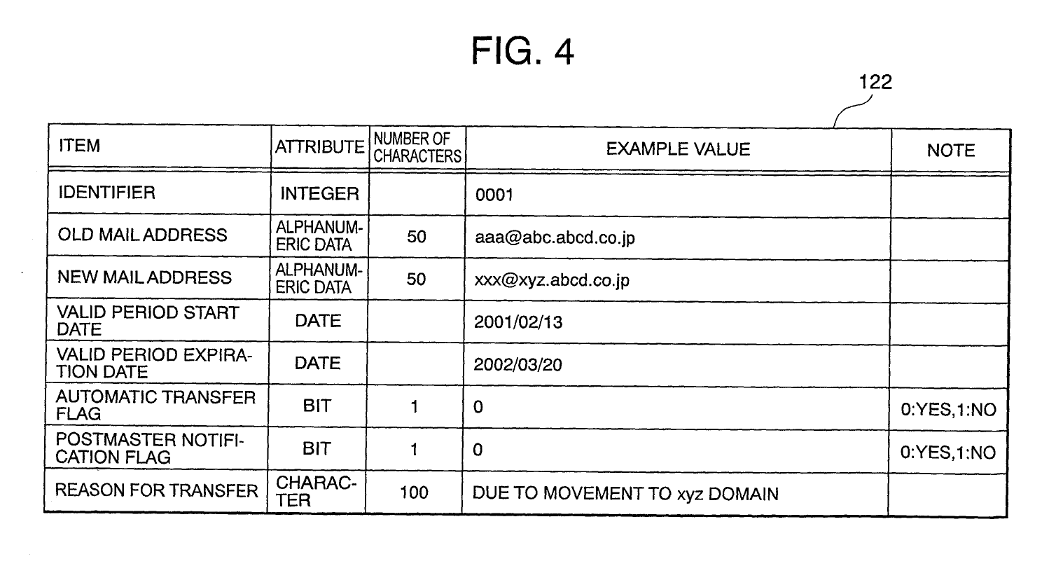

(1) When the mail address of the user A has been changed due to personnel reshuffle, an absence-response-list input screen 121 is displayed on a client 120 so as to accept data input of absence response information (hereinafter referred to as an “absence response list”). FIG. 3 shows an example of the absence-response-list input screen 121. Items displayed on the absence-response-list input screen 121 include information regarding a mail address change (including old mail address and new mail address); information regarding valid period of change (including period start date and period expiration date); information regarding an automatic transfer flag used for setting whether an absence response list is to be transferred automatically; information regarding a postmaster notification flag used for setting whether a report indicating occurrence of mail transfer is to be sent to the administrator of the server 150, who is a notice-receiver; and information regarding reason for mail transfer. FIG. 4 shows an example input-data format of the absence response list 122. Although not all the items displayed on the absence-response-list input screen 121 necessarily require input of data, at least the old mail address aaa@abc.abcd.co.jp and the new mail address xxx@xyz.abcd.co.jp must be input.

(2) When the user A clicks a “notify” button on the absence-response-list input screen 121 after completion of input of the absence response list 122, the input data of the absence response list 122 are transmitted to a mail server 110 (net.abc.abcd.co.jp).

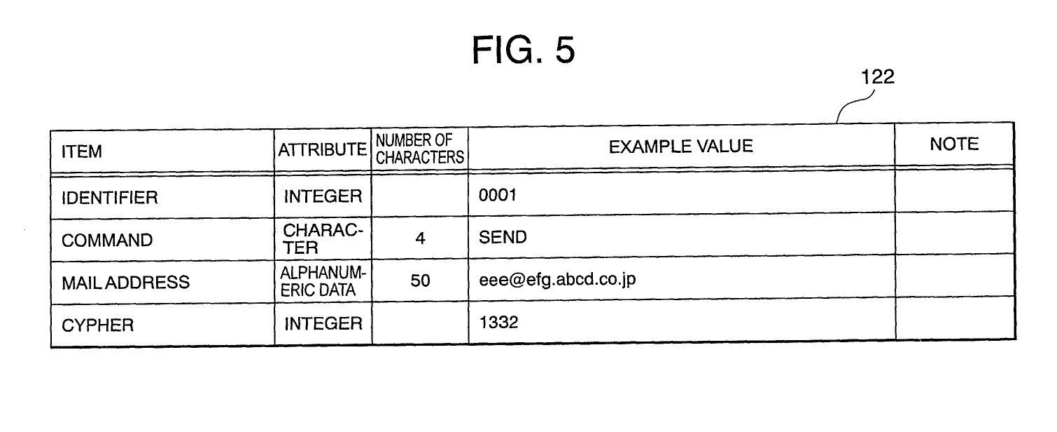

(3) The mail server 110 receives the input data of the absence response list 122 and registers the absence response list 122. Subsequently, among the mailing lists 112 stored in the mail server 110, the mail server 110 searches a mailing list 112 that contains, as a member, the old mail address aaa@abc.abcd.co.jp contained in the absence response list 122, and extracts a mail address of another member from a member list of the searched mailing list 112. FIG. 5 shows an example member list of the mailing list 112. The member list of the mailing list 112 includes an identifier, a command, a mail address, and a cypher. The mail address eee@efg.abcd.co.jp of the user B (identifier: 0001), who is another member, is extracted.

(4) The mail server 110 sends an nslookup command to a DNS server 130 together with the extracted mail address eee@efg.abcd.co.jp to thereby request provision of domain information of a notice-receiver, such as host name and domain name.

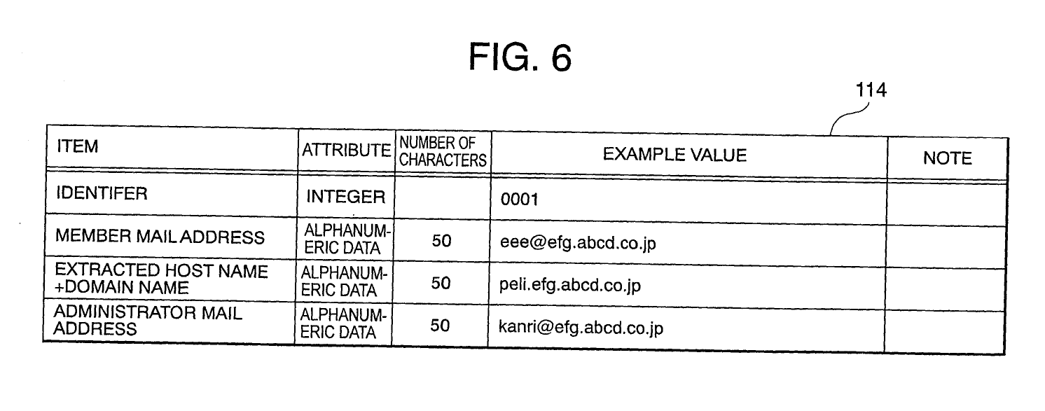

(5) In response to the request from the mail server 110, the DNS server 130 returns corresponding domain information 114 to the mail server 110. FIG. 6 shows example data of the domain information. The domain information includes an identifier, a member mail address, an extracted host name and domain name in combined form, and an administrator mail address. Thus, the mail server 110 can obtain the combined host/domain name (peli.efg.abcd.co.jp) of the user B and the administrator mail address (kanri@efg.abcd.co.jp).

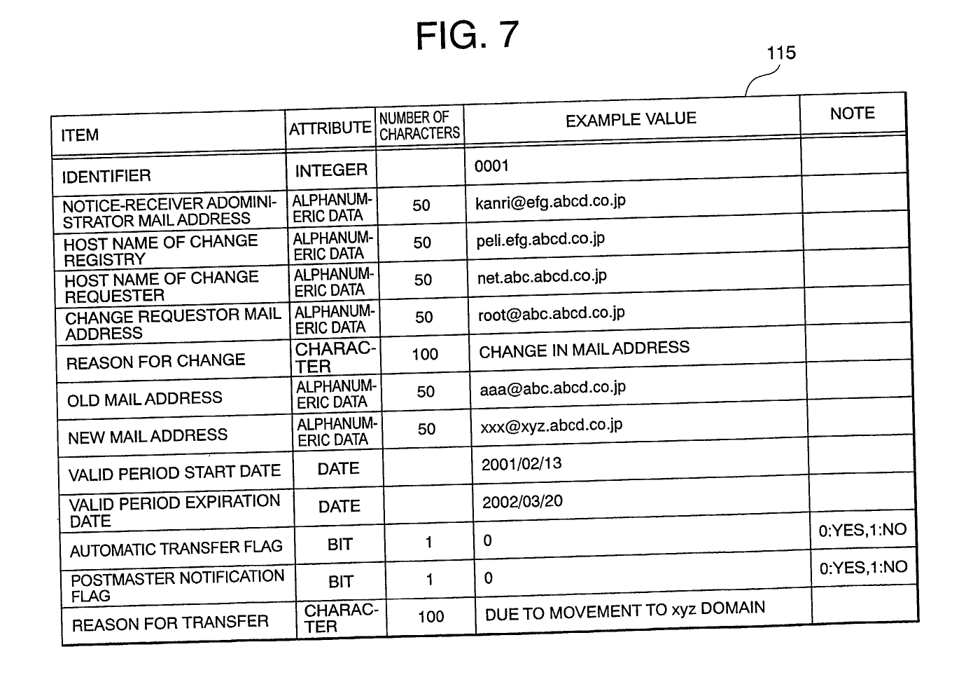

(6) The mail server 110 combines the absence response list 122 and the domain information 114 obtained from the DNS server 130 to thereby obtain a notice-destination domain file 115 as shown in FIG. 7. The notice-destination domain file 115 contains data items, including an identifier, an administrator mail address of a notice-receiver server, a change registry host name, a change requester host name, an administrator mail address of a change requester server, a reason for change, an old mail address, a new mail address, a start date of a valid period, an expiration date of the valid period, an automatic transfer flag, a postmaster notification flag, and a reason for mail transfer. The mail server 110 provides the notice-destination domain file 115 to a scheduler 140 and requests transmission of the absence response list 122.

(7) At predetermined times or occasions, the scheduler 140 refers to the notice-destination domain file 115 and transmits the corresponding absence response list 122 to a mail server 150 (peli.efg.abcd.co.jp), which is a notice-receiver.

(8) The mail server 150 registers the received absence response list 122.

(9) The user B transmits a mail 161 directed to the mail address aaa@abc.abcd.co.jp of the user A from a client 160.

(10) The mail server 150 accepts transmission of the mail 161 from the client 160 and refers to the stored absence response list 122. Since the transmission address of the mail 161 matches the old mail address contained in the absence response list 122, the mail server 150 transmits the mail 161 to a mail server 170 after replacing the old mail address with the new mail address xxx@xyz.abcd.co.jp.

(11) The mail server 170 receives the mail directed to the address xxx@xyz.abcd.co.jp. The user A receives the mail 161 from the mail server 170 in the form of a transfer mail 181.

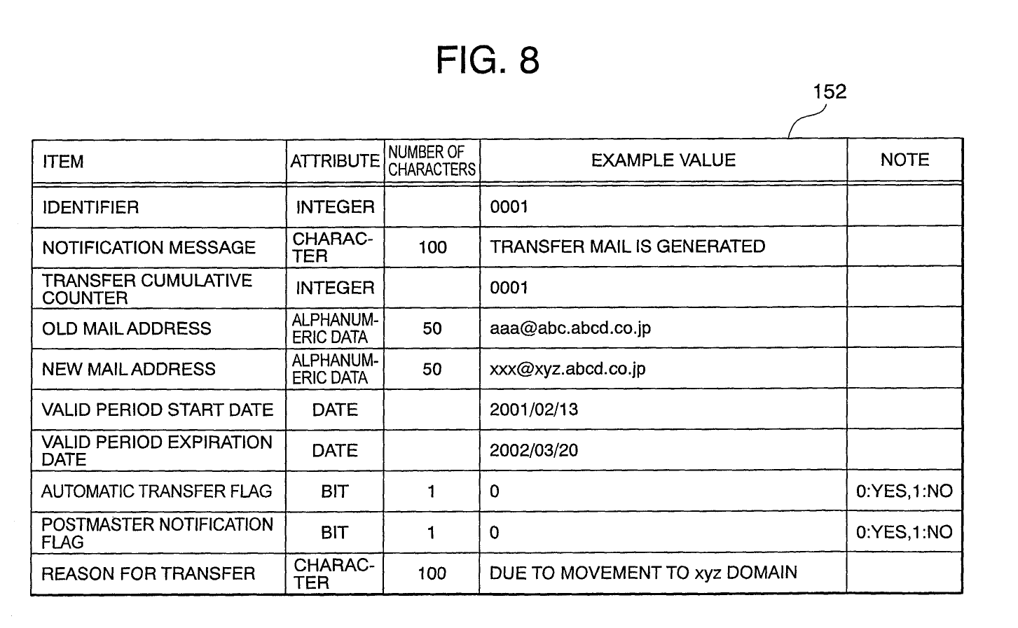

(12) The mail server 150 transmits to the postmaster (administrator) of the mail server 150 a notification message 152 reporting that the mail 161 has been transferred. FIG. 8 shows an example notification message to be sent to the postmaster. The notification message 152 includes an identifier, a notification message, a transfer commutative counter, an old mail address, a new mail address, a start date of a valid period, an expiration date of the valid period, an automatic transfer flag, a postmaster notification flag, and a reason for mail transfer. The same message may be sent to the client 160.

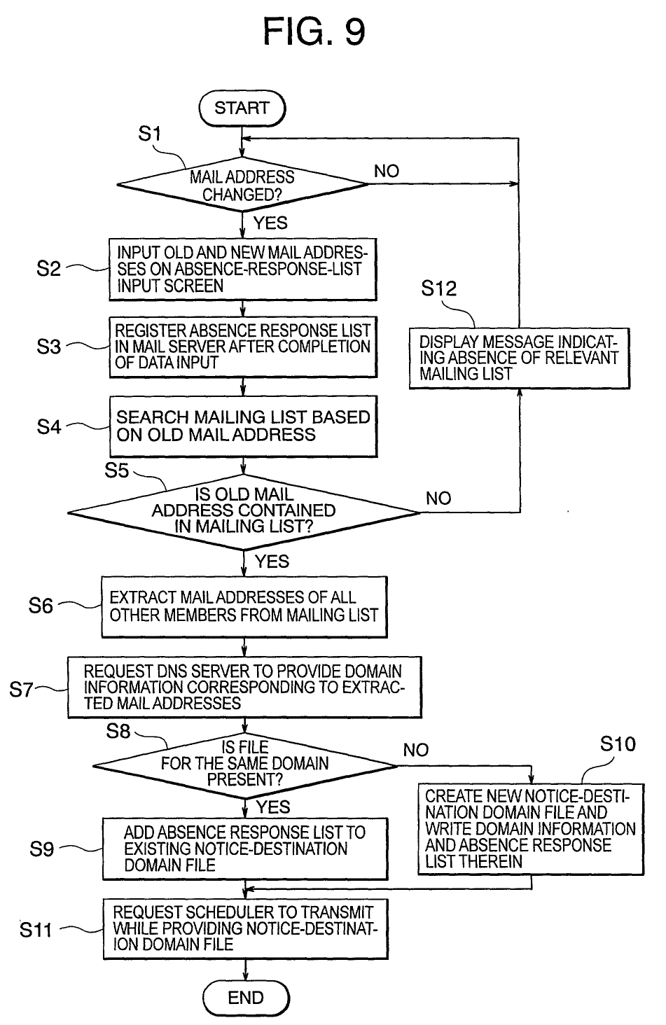

FIGS. 9 to 12 show a processing flow of the system according to the present invention shown in FIG. 2. FIG. 9 is a processing flowchart of the mail server 110 for the domain abc.abcd.co.jp.

When mail address change has occurred (step S1) and information regarding the mail address change has been input on the absence-response-list input screen 121 at the client 120 (step S2), the mail server 110 registers an absence response list 122 (step S3). Subsequently, the mail server 110 searches a mailing list 112 on the basis of the old mail address contained in the absence response list 122 (step S4). When the old mail address is contained in the mailing list 112 as a member (step S5), the mail server 110 extracts from the searched mailing list 112 mail addresses of all of other members (step S6), and, on the basis of the extracted mail addresses, requests the DNS server 130 to provide domain information 114 (step S7). The mail server 110 checks whether a notice-destination domain file 115 for the same domain as that of the obtained domain information 114 is present (step S8). When a notice-destination domain file 115 for the same domain as that of the obtained domain information 114 is present, the mail server 110 adds data of the absence response list 122 to the existing notice-destination domain file 115 (step S9). When a notice-destination domain file 115 for the same domain as that of the obtained domain information 114 is not present, the mail server 110 creates a new notice-destination domain file 115 and stores therein the data of the domain information 114 and the data of the absence response list 122 (step S10). Subsequently, the mail server 110 requests the scheduler 140, while sending the notice-destination domain file 115 thereto, to transmit the absence response list 122 (step S11), and then ends the processing. When the mail server 110 judges in step S5 that the old mail address is not contained in the mailing list 112, the mail server 110 displays a message indicating that no relevant mailing list is present (step S12) and ends the processing.

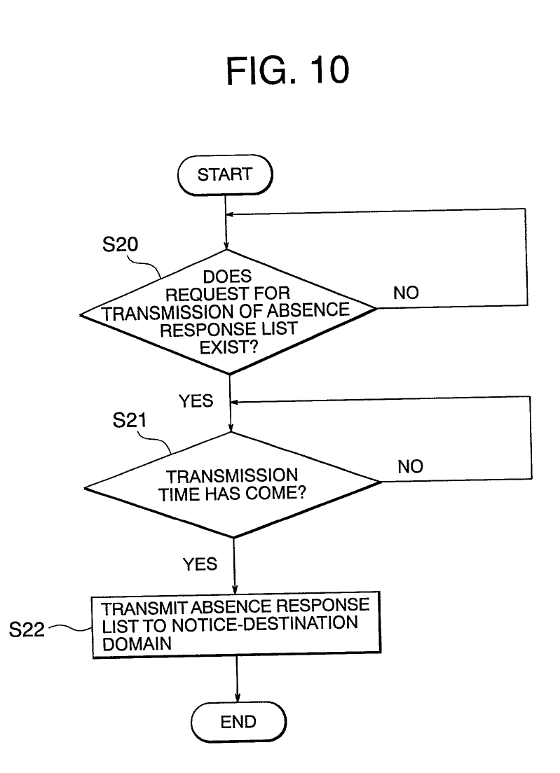

FIG. 10 is a processing flowchart of the scheduler 140 for the domain abc.abcd.co.jp. Upon existence of a request for transmitting the absence response list 122 (step S20), the scheduler 140 checks whether a transmission time has come (step S21). When a transmission time has come, with reference to the notice-destination domain file 115, the scheduler 140 transmits the absence response list 122 to the mail server 150 (step S22). The transmission of the absence response list 122 may be performed in such a manner that a plurality of absence response lists 122 are transferred together at a predetermined time or occasion or in such a manner that each absence response list 122 is transmitted immediately after reception of a transmission request.

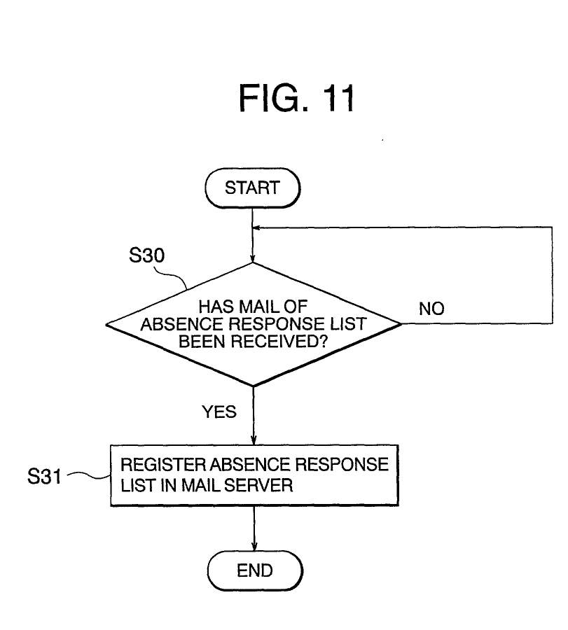

FIG. 11 is a processing flowchart of the absence response list reception processing of the mail server 150 for the domain efg.abcd.co.jp. Upon receipt of the absence response list 122 (step S30), the mail server 150 registers the absence response list 122 therein as the absence response list 151 (step S31).

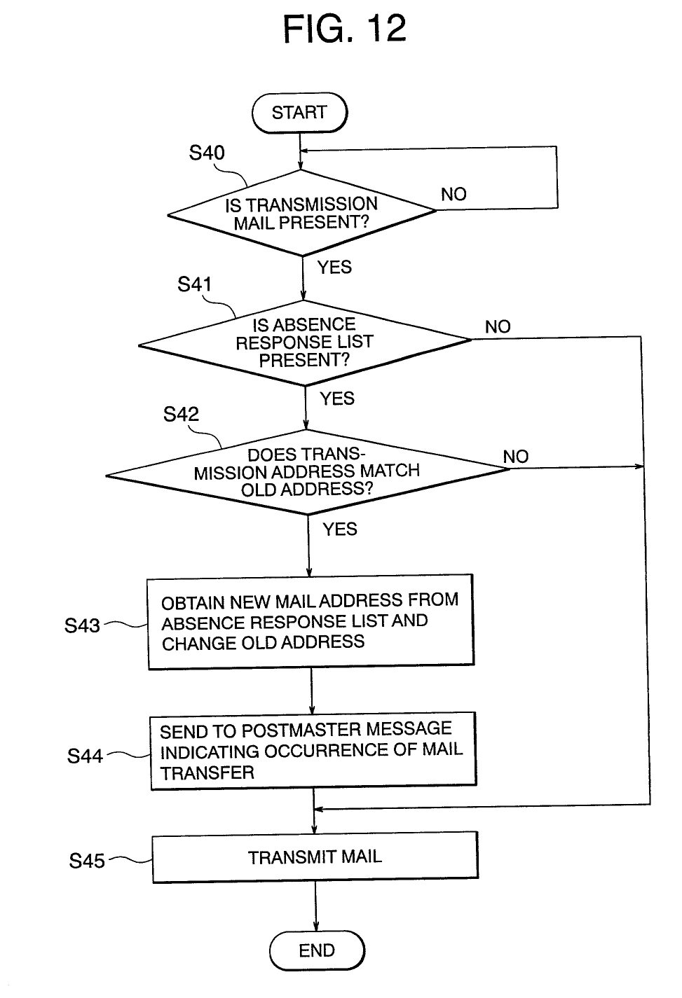

FIG. 12 is a processing flowchart of the transfer processing of the mail server 150 for the domain efg.abcd.co.jp. When the mail server 150 receives a transmission mail (step S40), the mail server 150 checks whether the absence response list 151 is present (step S41). When the transmission address of the mail matches the old mail address contained in the absence response list 151 (step S42), the mail server 150 replaces the old address of the transmission mail with the corresponding new address contained in the absence response list 151 (step S43). Subsequently, the mail server 150 notifies the postmaster that a transfer mail is present (step S44) and transmits the mail (step S45).

When the mail server 150 judges in step S41 that no absence response list 151 is stored in the mail server 150 or judges in step S42 that, the absence response list 151 is present but the transmission address of the mail does not match the old mail address contained in the stored absence response list 151, the mail server 150 transmits the mail as is (step S45).

As has been described above, in the present invention, before an error mail is generated due to a mail address change, a mail server which has received absence response information regarding the mail address change specifies a mail server to which absence response information is to be distributed, by use of address information stored in the mail server, such as a mailing list, and distributes the absence response information. A mail server which has received the absence response information registers the received absence response information, and when a mail directed to the old address contained in the absence response information is to be transmitted, the mail server transmits the mail to the new address.

As described above, a mail can be transferred to an effective new address through a single transmission operation, without error transmission, which otherwise is typically performed a plurality of times. Therefore, useless traffic produced due to generation of error mails can be suppressed.

Moreover, necessity of mail transfer can be judged automatically with reference to absence response information registered in the server. This lessens the workload of the server administrator, because the server administrator is released from the work of analyzing an error log and coping with the error.

Obviously, numerous modifications and variations of the present invention are possible in light of the above teachings. It is therefore to be understood that within the scope of the appended claims, the present invention may be practiced otherwise than as specifically described herein.

The program which realizes the respective means, functions, or elements of the present invention by use of a computer can be stored on a proper computer-readable recording medium such as transportable memory, semiconductor memory, or hard disk drive, and is provided in a state in which the program is recorded on the recording medium. Alternatively, the program of the present invention can be provided by means of data transmission performed via communication interfaces and various communication networks. Moreover, servers or clients that constitute the system according to the present invention can be realized by data processing units (CUP/memory) which can be connected to each other via various communication lines or by means of radio.

What is claimed is:

1. A message-address management program to cause a computer to perform message-address management processing in a system capable of exchanging messages among a plurality of servers, wherein the program causes the computer to perform:
absence-response-information accepting processing to receive, when a mail address of a certain member of a mail group changes, absence response information including at least an old address and a new address of the member;
notice-receiver extraction processing to extract a mail address of another member of the mail group from a previously provided mail list for the mail group;
notice-destination determination processing to specify a server to which the absence response information is to be provided, on the basis of the extracted mail address; and
absence-response-information distribution processing to distribute the absence response information to the specified server.

2. A message-address management program according to claim 1, wherein the absence response information received by the absence-response-information accepting processing contains information regarding a valid period of the absence response information.

3. A message-address management program according to claim 1, wherein the absence-response-information distribution processing distributes simultaneously a plurality of pieces of the absence response information to be distributed to the same server, to which the absence response information is to be provided.

4. A message-address management program to cause a computer to perform message-address management processing in a system capable of exchanging messages among a plurality of servers, wherein the program causes the computer to perform:
absence-response-information receiving processing to receive from a server absence response information including at least an old address and a new address of a certain member of a mail group;
absence-response-information management processing to store and manage the absence response information;
address judgment processing to judge whether an address of an accepted transmission mail matches the old address contained in the absence response information; and
transfer processing to transmit the mail after replacement of the address with the new address, when the address of the mail matches the old address contained in the absence response information.

5. A message-address management program according to claim 4, wherein the program further causes the computer to perform transfer notification processing, when the mail has been transferred to the new address by the transfer processing, in order to notify an administrator of the message exchange system or a requestor of the mail transmission that the mail has been transferred to the new address.

6. A message-address management program to cause a computer to perform message-address management processing in a system capable of exchanging messages among a plurality of servers, wherein the program causes the computer to perform:
absence-response-information creation processing to accept, when a mail address changes, an input data of absence response information including at least an old address and a new address corresponding to the change; and
absence-response-information provision processing to transmit the input data of the absence response information to the server.

7. A program recording medium storing a program to cause a computer to perform message-address management processing in a system capable of exchanging messages among a plurality of servers, wherein the program causes the computer to perform:
absence-response-information accepting processing, when a mail address of a certain member of a mail group changes, so as to receive absence response information including at least an old address and a new address of the member;
notice-receiver extraction processing to extract a mail address of another member of the mail group from a previously provided mail list for the mail group;
notice-destination determination processing to specify a server to which the absence response information is to be provided, on the basis of the extracted mail address; and
absence-response-information distribution processing to distribute the absence response information to the specified server.

8. A program recording medium according to claim 7, wherein the absence response information received by the absence-response-information accepting processing contains information regarding a valid period of the absence response information.

9. A program recording medium according to claim 7, wherein the absence-response-information distribution processing distributes simultaneously a plurality of pieces of the absence response information to be distributed to the same server, to which the absence response information is to be provided.

10. A program recording medium storing a program to cause a computer to perform message-address management processing in a system capable of exchanging messages among a plurality of servers, wherein the program causing the computer to perform:
absence-response-information receiving processing to receive from a server absence response information including at least an old address and a new address of a certain member of a mail group;
absence-response-information management processing to store and manage the absence response information;
address judgment processing to judge whether an address of an accepted transmission mail matches the old address contained in the absence response information; and
transfer processing to transmit the mail after replacement of the address with the new address, when the address of the mail matches the old address contained in the absence response information.

11. A program recording medium according to claim 10, wherein the program causes the computer to perform transfer notification processing, when the mail has been transferred to the new address by the transfer processing, in order to notify an administrator of the message exchange system or a requestor of the mail transmission that the mail has been transferred to the new address.

12. A program recording medium storing a program to cause a computer to perform message-address management processing in a system capable of exchanging messages among a plurality of servers, wherein the program causes the computer to perform:
absence-response-information creation processing to accept, when a mail address changes, an input data of absence response information including at least an old address and a new address corresponding to the change; and
absence-response-information provision processing to transmit the input data of the absence response information to the server.

13. A message-address management method for exchanging messages among a plurality of servers, the method comprising the steps of:
receiving, when a mail address of a certain member of a mail group changes, absence response information including at least an old address and a new address of the member;
extracting a mail address of another member of the mail group from a previously provided mail list for the mail group;
specifying a server to which the absence response information is to be provided, on the basis of the extracted mail address; and
distributing the absence response information to the specified server.

14. A message-address management method according to claim 13, wherein the absence response information received by the absence-response-information receiving step contains information regarding a valid period of the absence response information.

15. A message-address management method according to claim 13, wherein the absence-response-information distribution step distributes simultaneously a plurality of pieces of the absence response information to be distributed to the same server, to which the absence response information is to be provided.

16. A message-address management method for exchanging messages among a plurality of servers, the method comprising the steps of:
receiving from a server absence response information including at least an old address and a new address of a certain member of a mail group who uses the server;
storing and managing the absence response information;
judging whether an address of an accepted transmission mail matches the old address contained in the absence response information; and
transmitting the mail after replacement of the address with the new address, when the address of the mail matches the old address contained in the absence response information.

17. A message-address management method according to claim 16, further comprising the step of:
sending, when the mail has been transferred to the new address, a message to an administrator of the message exchange system or a requester of the mail transmission, the message reporting that the mail has been transferred to the new address.

18. A message-address management method for exchanging messages among a plurality of servers, the method comprising the steps of:
accepting, when a mail address changes, an input data of absence response information including at least an old address and a new address corresponding to the change; and
transmitting the input data of the absence response information to the server.

19. A message-address management apparatus for exchanging messages among a plurality of servers, the apparatus comprising:
absence-response-information accepting means for receiving, when a mail address of a certain member of a mail group changes, absence response information including at least an old address and a new address of the member;
notice-receiver extraction means for extracting a mail address of another member of the mail group from a previously provided mail list for the mail group;
notice-destination determination means for specifying a server to which the absence response information is to be provided, on the basis of the extracted mail address; and
absence-response-information distribution means for distributing the absence response information to the specified server.

20. A message-address management apparatus according to claim 19, wherein the absence response information received by the absence-response-information accepting means contains information regarding a valid period of the absence response information.

21. A message-address management apparatus according to claim 19, wherein the absence-response-information distribution means distributes simultaneously a plurality of pieces of the absence response information to be distributed to the same server, to which the absence response information is to be provided.

22. A message-address management apparatus for exchanging messages among a plurality of servers, the apparatus comprising:
absence-response-information receiving means for receiving from a server absence response information including at least an old address and a new address of a certain member of a mail group;
absence-response-information management means for storing and managing the absence response information;
address judgment means for judging whether an address of an accepted transmission mail matches the old address contained in the absence response information; and
transfer means for transmitting the mail after replacement of the address with the new address, when the address of the mail matches the old address contained in the absence response information.

23. A message-address management apparatus according to claim 22, further comprising transfer notification means for sending, when the mail has been transferred to the new address by the transfer means, a message to an administrator of the message exchange system or a requester of the mail transmission, the message reporting that the mail has been transferred to the new address.

24. A message-address management apparatus for exchanging messages among a plurality of servers, the apparatus comprising:
absence-response-information creating means for accepting, when a mail address changes, an input data of absence response information including at least an old address and a new address corresponding to the change; and
absence-response-information providing means for transmitting the input data of the absence response information to the mail server.
